(19) United States
(12) Patent Application Publication
(10) Pub. No.: US 2010/0236843 A1
(43) Pub. Date: Sep. 23, 2010

(54) DATA INPUT DEVICE

(75) Inventor: Häkan ENGLUND, Haninge (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/408,425

(22) Filed: Mar. 20, 2009

(51) Int. Cl. G06F 3/041

(52) U.S. Cl. 178/18.03

(57) ABSTRACT

A data input device may include a touch input interface having a touch sensing mechanism, and a plurality of regions of material that is arranged to change its shape, size or rheology on application of an applied voltage. The data input device may activate a region of the plurality of regions of material touched by a user by applying a voltage in the region to change the shape, size, or rheology of material in the region on detection of a user touch in the region by the touch sensing mechanism to provide a tactile indication of the region touched by the user.

### TECHNICAL FIELD

The present invention concerns a data input device and a device including a data input device.

### BACKGROUND OF THE INVENTION

Many portable computer or electronic devices, such as laptop computers, mobile telephones, portable multimedia players, include a tactile data input device. The tactile data input device may include a touch input interface such as a touchpad, a trackball, jog wheel or click wheel, for scrolling or selecting items from a menu for example. A user provides input by touching and moving the touch input interface or by touching and sliding a finger or stylus across the touch input interface.

A problem with such a tactile data input device is that no tactile feedback as regards the movement, position or orientation of the touch input interface is provided to the user. A user is therefore “tactilly blind” in that he/she cannot feel the effect of his/her actions on the computer or electronic device using his/her sense of touch but must depend on a visual or auditory response from the computer or electronic device. There is for example no way for a user to sense the volume level that he/she has previously selected via the touch input interface of a tactile data input device just by touching the touch input interface, i.e. without looking at a display or listening to an audio feedback signal provided by the device.

### SUMMARY OF THE INVENTION

An object of the invention is to overcome or ameliorate at least one of the disadvantages of the prior art, or to provide a useful alternative. A further object of the present invention is to provide an improved data input device that provides a user with tactile feedback.

At least one of these objects is achieved by a data input device comprising a two or three-dimensional touch input interface having a touch sensing mechanism and a plurality of regions, i.e. areas or volumes of any size or shape, of material that is arranged to change its shape, size or rheology on application of a voltage. The data input device is arranged to at least temporarily activate a final region of material touched by a user by applying a voltage in that region to change the shape/size/rheology of material in that region on detection of a user's touch in that region by the touch sensing mechanism, and thereby provide a tactile indication of the final region touched by the user. Each region may comprise electrodes or be arranged so that a voltage can be applied thereto in order to change the shape, size and/or rheology of at least part of the material in that region, a single pair of electrodes may for example be arranged to activate a plurality of regions of material. The touch input interface may be stationary, i.e. non-displaceable and non-rotatable, with respect to the data input device and/or a device that contains the data input device.

Such a data input device may provide a user with a simple, intuitive, tactile indication of a previous movement/position of a user's finger/stylus over a touch input interface and, since it may be arranged to have no moving/rotating mechanical parts, it can eliminate the potential failures that can occur in data input devices comprising moving/rotating mechanical tactile indicators, such as a conventional mechanical slider or rotatable wheel. A user may, for example, be able use his fingertip or a stylus to feel the volume level that has been selected via a linear touch input interface (i.e. whether the volume is high or low) simply by tactilly determining how far along the touch input interface the tactile indication has been provided and without needing to look at a graphic icon on a display or to listen to an audio feedback signal.

The expression “touch input interface” is intended to mean an interface via which a user provides input, such as commands and/or information, by touching and moving the touch input interface or by touching and sliding a finger, a stylus or some other object over the touch input interface. It is not intended to include an interface, such as a push-button or touch screen area, via which a user provides input by merely touching or pressing said interface. The touch input interface may be used to control one or more functions of one or more devices, to navigate/scroll within an application or between different applications of a device or to control a cursor on a display of a device and thereby select different functions, commands or applications.

It should be noted that a “plurality of regions of material” does not necessarily mean that each region of material is separate and distinct from other regions. A data input device consistent with aspects described herein could namely comprise a single area/volume of material that is in effect divided into a plurality of regions by arranging electrodes within said area/volume of material to locally activate one or more parts of the area/volume of material.

It should be understood that a data input device according to the present invention need not necessarily be arranged to activate a single region of material but it may be arranged to activate a plurality of adjacent regions of material to facilitate the tactile indication of the final region(s) of material touched by the user.

According to an embodiment, the material may be an electroactive polymer (EAP) (also known as “electronic muscle” or “artificial muscle”) whose size/shape is reversibly modified when a voltage is applied to it. Alternatively, the material may be a smart fluid whose properties can be changed by applying an electric or magnetic field, such as an electro-rheological fluid whose viscosity and volume can be reversibly changed by in response to the application of an electric field. The material may alternatively be a piezoelectric material whose dimensions change (reversibly) when an electric field is applied thereto (the so-called converse piezoelectric effect). A data input device may comprise a plurality of different materials that are arranged to change their shape, size or rheology on application of an applied voltage in different regions thereof.

According to an embodiment, the data input device may be arranged to at least temporarily activate all regions of material touched by a user as the user is touching them by applying a voltage to the regions touched by a user to change the shape/size of material in each of those regions on detection of a user's touch in those regions by the touch sensing mechanism. A user will therefore feel as though he/she is moving a virtual mechanical slider under his fingertip/stylus since the sequentially activated regions will follow (target track) the movement of his/her fingertip/stylus.

According to another embodiment, the data input device may be arranged to cause an activated region of material to become de-activated, such as by removing the voltage applied to that region, so that the material in that region returns to its original shape/size or a deactivated shape/size if/when a user subsequently touches an region of material adjacent to the activated region of material.

According to a further embodiment, the data input device may be arranged to apply sequentially increasing/decreasing voltages to regions that have been sequentially activated.

According to an embodiment, the data input device may be arranged to cause the final region touched by a user to provide further tactile feedback, such as to cause it to pulsate, vibrate, heat up, cool down or move.

According to another embodiment, the data input device may arranged to de-activate all activated regions of material when the touch input interface/the data input device is out of operation, i.e. when the input interface/the data input device has been switched off or has not been used for a predetermined amount of time. In this way battery and processing power may be saved while the input interface/the data input device is not in operation. According to a further embodiment, the data input device may include a storage unit that is arranged to store information concerning the final region of material touched by a user or user preferences. A data input device may be arranged to re-activate a de-activate a final region of material touched by a user using information in the storage unit when the touch input interface/the data input device is brought back into operation or on request from a user.

According to another embodiment, the touch input interface may be a planar surface, is in the form of a disc or constitutes at least part of a three dimensional shape, operative to input data to a processor for example based on a location of user contact on the touch surface.

According to a further embodiment, the plurality of regions of material may be arranged to cover the entire area/volume of the touch input interface so as to provide a smoother and more continuous feel as a user slides a finger/stylus over the touch input interface.

Further, a device may be a portable device, such as a mobile telephone, media player, Personal Communications System (PCS) terminal, Personal Data Assistant (PDA), laptop computer, games console, mixing console, palmtop receiver, camera or television.

According to yet another embodiment, the touch input interface of the device may be recessed in a surface so as to protect any activated region(s) from being damaged if the device is dropped for example or from any non-activated regions from being accidentally activated.

### BRIEF DESCRIPTION OF THE DRAWINGS

The present invention will hereinafter be further explained by means of non-limiting examples with reference to the appended schematic figures where;

FIG. 1 shows a device according to an embodiment of the invention,

FIGS. 2 & 3 show a cross section of a touch input interface of a data input device according to an embodiment of the invention,

FIG. 4 shows a data input device according to an embodiment of the invention,

FIG. 5 shows a touch input interface according to an embodiment of the invention and a conventional mechanical control interface,

FIG. 6 shows a touch input interface according to an embodiment of the invention, and

FIGS. 7 & 8 show cross sections of touch input interfaces of data input devices according to an embodiment of the invention.

It should be noted that the drawings have not been drawn to scale and that the dimensions of certain features have been exaggerated for the sake of clarity.

### DETAILED DESCRIPTION OF EMBODIMENTS

FIG. 1 shows a device 10, namely a mobile telephone, according to an embodiment of the invention. The device 10 comprises a display 12, such as a cathode ray tube, a flat panel display, a light emitting diode (LED) display, an electroluminescent display (ELD), a plasma display panel (PDP) or a liquid crystal display (LCD) and a touch input interface 14, shown as a flat two-dimensional rectangular area in the illustrated embodiment. It should be noted that the touch input interface 14 may constitute at least a part of a display 12 of a device.

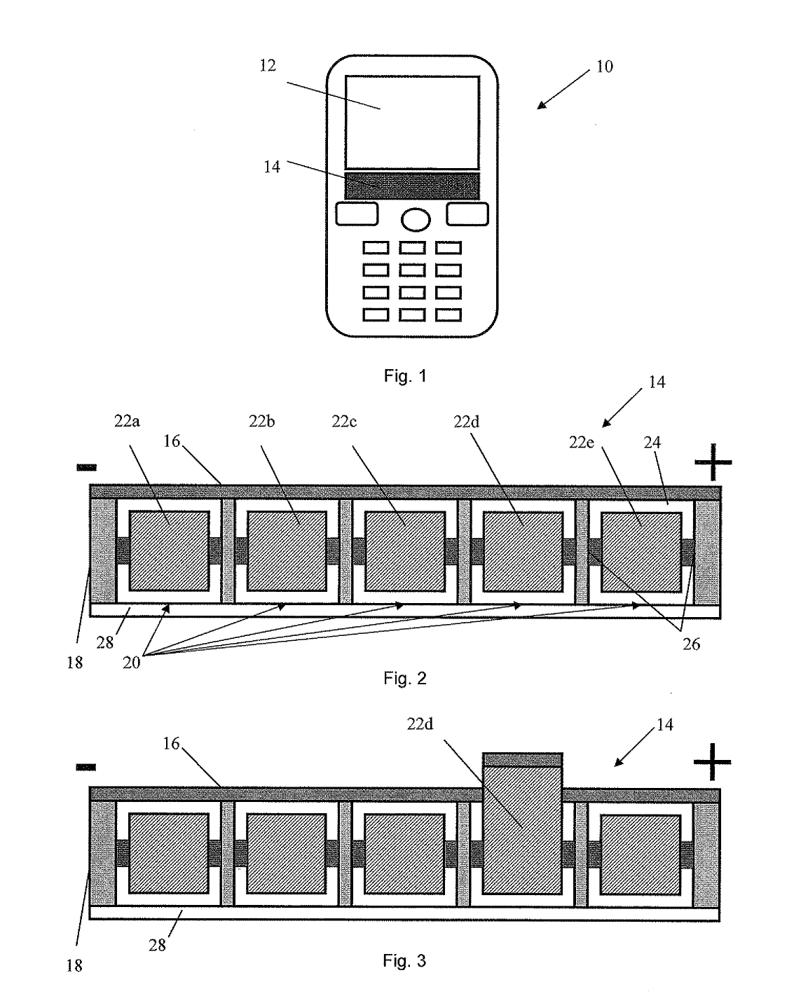

FIG. 2 shows a cross section of a touch input interface 14 of a data input device according to an embodiment of the invention. The touch input interface 14 in the illustrated embodiment includes a transparent or non-transparent elastic shielding layer 16, such as a flexible silicone layer, having an upper surface that constitutes an outer surface of the device 10. A solid substrate 18 is provided under the shielding layer 16. The solid substrate 18 includes a plurality of cavities 20, which, in the illustrated embodiment, extend all the way through the solid substrate 18 although this does not necessarily need to be the case.

Each cavity 20 contains a region 22a, 22b, 22c, 22d and 22e of material that is arranged to change its shape, size or rheology on application of an applied voltage. The material may be an electroactive polymer (EAP), such as an ionic electroactive polymer or an ionomeric polymer-metal composite or a carbon nanotube. Each cavity 20 may be completely or only partly filled with EAP, whereby, in the latter case, the EAP may be surrounded by electrolyte 24 in the form of a gel for example in order to protect the EAP.

Each cavity 20 is provided with two electrodes 26 and when a voltage is applied between the electrodes 26, the EAP 22a, 22b, 22c, 22d, 22e reacts and changes its size. Since the shielding layer 16 is more flexible than the bottom and side walls of the cavities 20 the EAP will expand or contract and thus raise or lower the flexible shielding layer 16 in the activated EAP region.

The device 10 comprises a touch sensing mechanism 28 located below the solid substrate 18 in the illustrated embodiment, which may comprise a resistive, capacitive or piezoelectric touch panel. A display 12 may be provided under the touch sensing mechanism 28. According to an alternative embodiment of the invention the touch sensing mechanism 28 may comprise piezoelectric material that is arranged to generate an applied voltage that may be used to change the size/shape/rheology of the EAP 22a, 22b, 22c, 22d, 22e when a user touches the touch input interface 14.

If a user slides his/her finger along the shielding layer 16 from region 22a to region 22d, in order to increase the volume of music being played by a device 10, the pressure exerted on the touch input interface 14 will force the EAP regions 22a-22d and surrounding electrolyte to be forced downwards onto an area of the underlying touch sensing mechanism 28. The data input/selection made by the user will be communicated to an appropriate part of the device 10, such as to a control unit thereof and the volume of music being played will be changed to the level selected by the user. The device 10 will at least temporarily activate the final region 22d of EAP touched by the user by applying a voltage to the electrodes in that region 22d to change the size of material in that region 22d and thereby provide a tactile indication of the final region 22d touched by the user.

FIG. 3 shows the touch input interface 14 shown in FIG. 2 when the final region of EAP touched by a user, region 22d, has been activated. It should be noted that an activated region 22d may alternatively be lowered with respect to the surrounding regions 22a, 22b, 22c and 22e in order to provide a tactile indication of the final region 22d touched by the user. It should also be noted that the shielding layer 16 may comprise openings to allow for the expansion/contraction of a region 22d of EAP when it has been activated/de-activated (as shown in FIG. 3) rather than an elastic layer capable of expanding and contracting.

According to an embodiment of the invention the device 10 is arranged to at least temporarily activate all regions of material touched by a user 22a-22d by applying a voltage to the electrodes 26 in all of these regions 22a-22d sequentially on detection of a user's touch in these regions 22a-22d by the touch sensing mechanism 28. Activated regions 22a-22c of material may then become de-activated by removing the voltage applied to the electrodes 26 in those regions 22s-22c, so that the material in those regions 22a-22c returns to its original shape/size or a deactivated shape/size if/when a user subsequently touches an region of material adjacent to the activated region of material. For example, as a user slides his finger from region 22a to 22b, region 22a will become de-activated when region 22b is activated in order to give the user the impression that he/she is moving a conventional mechanical slider, said slider being constituted by sequentially activated regions of material.

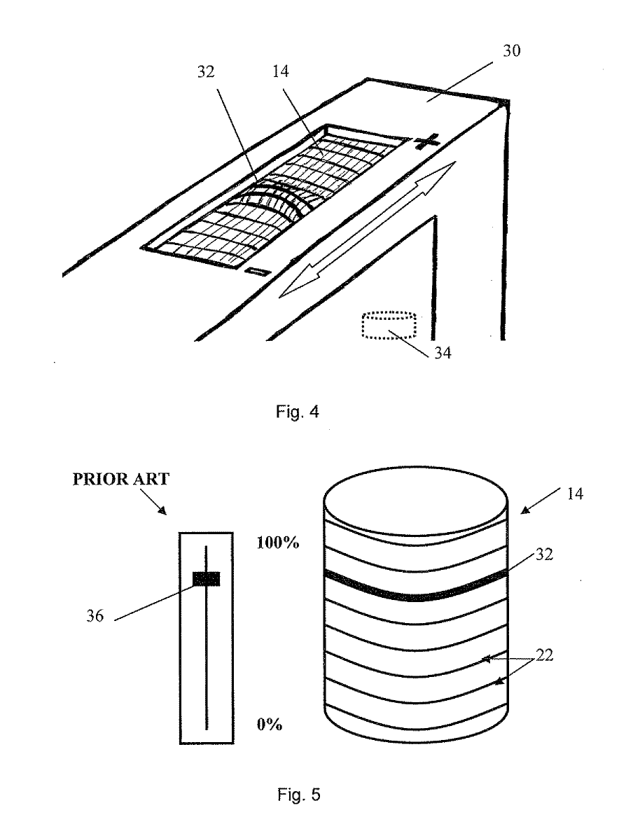

FIG. 4 shows a data input device 30 according to an embodiment of the invention comprising a planar touch input interface 14 that is recessed in a surface of the device 30. Such a data input device may constitute an integral part of a device 10, such as a mobile telephone, media player, Personal Communications System (PCS) terminal, Personal Data Assistant (PDA), laptop computer, games console, mixing console, palmtop receiver, camera or television or it may be located remotely thereto and in wireless communication therewith.

The touch input interface 14 shows an activated region 32 of material as the user would see it. It should be noted that even though the activated region 32 is visible to a user (and may be made more visible so by illuminating it for example) the aim of the invention is to provide a tactically detectable region (32) that may be detected by a user's sense of touch alone. It should be noted that the final region of material touched by a user may be activated by lowering at least the region(s) surrounding the final region instead of, or as well as activating the final region of material touched by user by raising it.

If a user puts his/her finger or thumb onto the touch input interface 14 to feel for the activated region, the data input device may be arranged not to activate any region of material before the user has touched the activated region 32, i.e. the user initiates data input and consequently the activation of other regions of material by touching the activated region 32 first (as would be the case if the activated region 32 was a conventional mechanical slider) and then sliding his/her finger or thumb so that it touches a region of material that is adjacent to the activated region 32. However the touch input device 30 may alternatively or additionally arranged to allow a user to initiate data input and consequently the activation of other regions without having to touch the activated region 32 first.

A data input device according to the present invention may be arranged to have a “start friction” meaning that a user may move his finger over an activated/de-activated region just to detect its location while applying a low force/pressure in the z-direction (i.e. the direction perpendicular to the plane of an activated/de-activated region in which direction the region is pressed to activate/de-activate it). The user may then press the activated/de-activated region harder to activate/de-activate it. A sensor, such as a resistive touch array, may for example be used to detect how hard a user is pressing an activated/de-activated region whereby the start friction may be overcome if the user presses a region with a force in the z-direction that exceeds a predetermined threshold. This more closely simulates the feeling of pushing a conventional mechanical slider.

The data input device 30 may be arranged to automatically de-activate the activated region 32 of material if/when the touch input interface 14 and/or the data input device 30 and/or the device 10 operated thereby is out of operation or has not been used for a predetermined time in order to save processing and battery power. The data input device 30 may comprise a storage unit 34 that is arranged to store information concerning the final region of material touched by a user, namely activated region 32. The data input device 30 may thus be arranged to re-activate a de-activated final region of material touched by a user using information stored in the storage unit 34 when the touch input interface 14 and/or the data input device 30 is brought back into operation or on receiving a request from a user. The storage unit 34 may also be used to store a user's preferences.

FIG. 5 shows a touch input interface 14 according to an embodiment of the invention in the form of a stationary cylinder whose surface comprising a plurality of strings, such as strings having a diameter of a few microns or less, of material 22 that is arranged to change its shape, size or rheology on application of an applied voltage thereto. The strings of material 22 may be spaced apart, as shown in FIG. 5, or may be arranged to cover the entire area/volume of a touch input interface 14, such as by overlapping or interlacing the strings of material 22 along the entire length and/or breadth of the touch input interface 14. One of the strings of material 32 is shown in an activated state.

Such a touch input interface 14 is comparable to a conventional mechanical control slider 36 as regards how it feels to a user although the touch input interface 14 of a data input device according to the present invention may be arranged to have no mechanically moving parts.

A device 10 according to the present invention may of course comprise a plurality of touch input interfaces 14 whereby a user can determine the movement/position/orientation of a plurality of touch input interfaces 14 using his/her sense of touch alone.

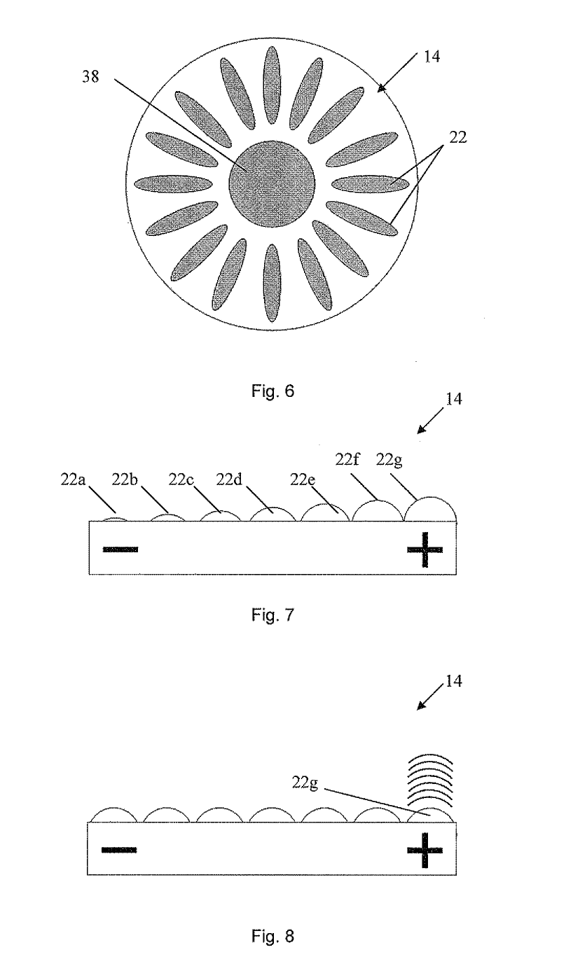

FIG. 6 shows a touch input interface 14 according to an embodiment of the invention in the form of a disc. The touch input interface 14 is provided with a plurality of regions of material 22 that is arranged to change its shape, size and/or rheology on application of an applied voltage thereto. The regions of material 22 could be dots of material 22 that are large enough to be tactilly detectable by a user. The touch input interface 14 may also comprise a button/area/volume 40 for a user to input data. The button/area/volume 40 may for example allow a user to de-activate a region of material 22 by means of tapping/pressing the button/area/volume 40 a predetermined number of times.

FIG. 7 shows a touch input interface 14 of a device 10 according to an embodiment of the invention which device 10 is arranged to apply sequentially increasing voltages to electrodes in regions that have been sequentially activated. FIG. 7 shows a cross section of the touch input interface 14 which shows hemispherical activated regions 22a-22g whereby it can be seen that a user moved his/her finger from region 22a to region 22g. A user will therefore be able to determine that region 22g was the final region that was activated using his/her sense of touch alone.

FIG. 8 shows a touch input interface 14 of a device 10 according to an embodiment of the invention which device 10 is arranged to cause the final region 22g touched by a user to provide further tactile feedback, such as to cause it to pulsate, vibrate, heat up, cool down or move. All of the regions 22a-22g of material activated by a user may however be arranged to provide further tactile feedback. A device 10 may, for example, sequentially increase the amount of vibration of a region 22a-22g of material from the first region 22a touched by a user to the final region 22g touched by user.

Further modifications of the invention within the scope of the claims would be apparent to a skilled person. For example, even though the claims are directed to a data input device having a plurality of regions of material that is arranged to change its shape, size or rheology on application of an applied voltage, the data input device according to the present invention could alternatively comprise a plurality of regions of material that is arranged to change its shape, size or rheology on application of magnetic field in which case each region need not necessarily comprise electrodes.

Furthermore, the data input device according to the present invention may also be used for outputting forces to a user thereof as well as, or instead of being used for inputting data.

1. A data input device including a touch input interface that comprises:
a touch sensing mechanism, and
a plurality of regions of material that are arranged to change shape, size or rheology on application of a voltage, the data input device activating a region, on detection of a user touch in the region by the touch sensing mechanism, of the plurality of regions of material by applying a voltage in the region to change the shape, size, or rheology of material in the region to provide a tactile indication of the region touched by the user.

2. The data input device of claim 1, wherein said material is an electroactive polymer (EAP), a smart fluid such as an electrorheological fluid, or a piezoelectric material.

3. The data input device according to claim 1, wherein the data input device is arranged to at least temporarily activate all of the plurality of regions of material that are touched by the user by applying a voltage to the regions touched by the user to change the shape or size of material in each of the regions touched by the user on detection of the user touch by said touch sensing mechanism.

4. The data input device according to claim 1, wherein the data input device is arranged to cause an activated region of material to become de-activated so that the material in that region returns to a deactivated shape or size when the user subsequently touches a region of material adjacent to the activated region of material.

5. The data input device according to claim 4, wherein the data input device is arranged to apply sequentially increasing or sequentially decreasing voltages to regions that have been sequentially activated.

6. The data input device according to claim 1, the data input device providing further tactile feedback to a final region touched by the, the additional tactile feedback including one or more of causing the final region to pulsate, vibrate, heat up, cool down or move.

7. The data input device according to claim 1, the data input device being arranged to de-activate all activated regions of material when said touch input interface of the data input device is not in operation.

8. The data input device according to claim 7, wherein the data input device is arranged to re-activate the de-activated final region of material touched by the user using information in the storage unit when said touch input interface of the data input device is brought back into operation.

9. The data input device according to claim 1, wherein the data input device further includes:
a storage unit arranged to store information concerning a final region of material touched by a user.

10. The data input device according to claim 1, wherein the touch input interface includes a planar surface in the form of a disc or constitutes at least part of a three dimensional shape.

11. The data input device according to claim 1, wherein the plurality of regions of material are arranged to cover the entire area or volume of the touch input interface.

12. The data input device according to claim 1, where the data input device includes a mobile telephone, a media player, a Personal Communications System (PCS) terminal, a Personal Data Assistant (PDA), a laptop computer, a game console, a mixing console, a palmtop receiver, a camera, or television.

13. The data input device according to claim 1, where the touch input interface is recessed in a surface of the data input device.

14. A touch interface device comprising:
a plurality of regions of material that each include a property that changes on application of a voltage; and
a touch sensing mechanism corresponding to the plurality of regions, the touch sensing mechanism sensing a user touch of one or more of the plurality of regions of material, the touch interface device activating, in response to the user touch, corresponding regions of the plurality of regions of material by applying a voltage to the corresponding regions to change the property of the material in the corresponding regions.

15. The touch interface of claim 14, where the property of the material is a property that causes a change in a tactile property of the material.

16. The touch interface of claim 14, where the property of the material is a property that causes a change in the shape, size, or rheology of the material.
